(19) United States
(12) Patent Application Publication
(10) Pub. No.: US 2014/0042743 A1
(43) Pub. Date: Feb. 13, 2014

(54) TANK OR BULKHEAD CONNECTION WITHOUT WELDING OR REQUIRING INTERNAL TANK ACCESS

(71) Applicant: Christopher G. Hough, Sharpsburg, GA (US)

(72) Inventor: Christopher G. Hough, Sharpsburg, GA (US)

(21) Appl. No.: 13/962,931

(22) Filed: Aug. 8, 2013

Related U.S. Application Data
(60) Provisional application No. 61/681,139, filed on Aug. 8, 2012.

(51) Int. Cl. F16L 23/032

(52) U.S. Cl. CPC F16L 23/032
USPC 285/368

(57) ABSTRACT

A tank or bulkhead connection allows attaching a device to a tank without welding or requiring internal tank or other side of bulkhead access. Two flange halves can be passed through a pre-drilled hole pattern to allow an outer flange and a gasket to be fastened to the inner halves, thus clamping the flanges to the tank/bulkhead. This allows the tank connection to be installed without welding and avoids total fluid draining and attendant environmental and safety considerations.

### CROSS-REFERENCE TO RELATED APPLICATION

This application claims the benefit of priority of U.S. provisional application No. 61/681,139, filed Aug. 8, 2012, the contents of which are herein incorporated by reference.

### BACKGROUND OF THE INVENTION

The present invention relates to tank or bulkhead connections and, more particularly, to a tank or bulkhead connection that does not require welding or internal tank or other side access.

Current solutions for connecting an attachment to a tank require a welded connection to the tank/bulkhead. Welding on a tank containing flammable vapors is unsafe and prohibitive. Other solutions require draining the tank and internally accessing the tank.

As can be seen, there is a need for an improved method and system for making a tank connection without welding or requiring internal tank access.

### SUMMARY OF THE INVENTION

In one aspect of the present invention, a tank connection device comprises at least first and second flange components adapted to fit inside an opening formed in a top of a tank, the first and second flange components forming a donut shaped second flange; a plurality of bolts extending from the first and second flange halves and extending through bolt holes formed in the top of the tank; and a gasket fitting about the bolts.

In another aspect of the present invention, a tank connection device comprises at least first and second flange components adapted to fit inside an opening formed in a top of a tank, the first and second flange components forming a donut shaped second flange; a plurality of bolts extending from the first and second flange halves and extending through bolt holes formed in the top of the tank; a gasket fitting about the bolts; an outside flange formed in a donut shape and having outside flange holes for receiving the plurality of bolts therein; and counter sunk screws fitting through the outside flange and threading into the first and second flange components.

These and other features, aspects and advantages of the present invention will become better understood with reference to the following drawings, description and claims.

### BRIEF DESCRIPTION OF THE DRAWINGS

FIG. 1 is a perspective view of a tank/bulkhead having a tank connection connected thereto, according to an exemplary embodiment of the present invention;

FIG. 2 is a cross-sectional view taken along line 2-2 of FIG. 1; and

FIG. 3 is a partially cut-away, exploded, perspective view of the tank having the tank connection connected thereto, as shown in FIG. 1, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a tank or bulkhead connection for attaching a device to a tank without welding or requiring internal tank or other side of bulkhead access. Two flange halves can be passed through a pre-drilled hole pattern to allow an outer flange and a gasket to be fastened to the inner halves, thus clamping the flanges to the tank/bulkhead. This allows the tank connection to be installed without welding and avoids total fluid draining and attendant environmental and safety considerations.

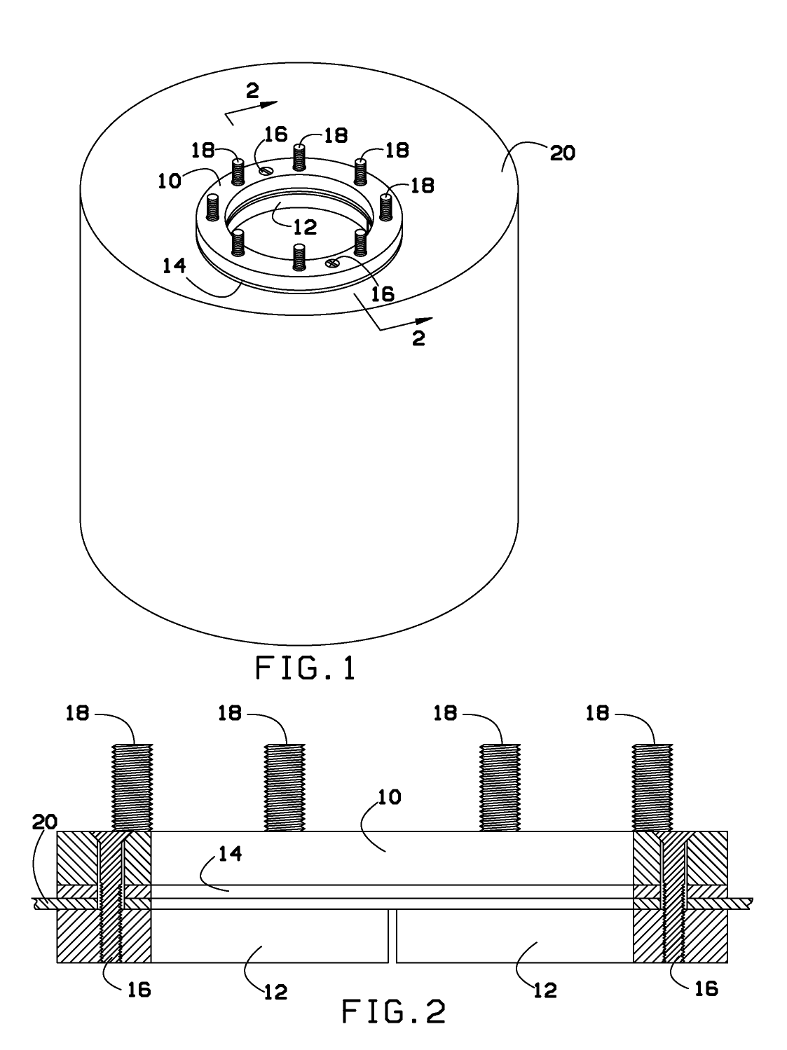

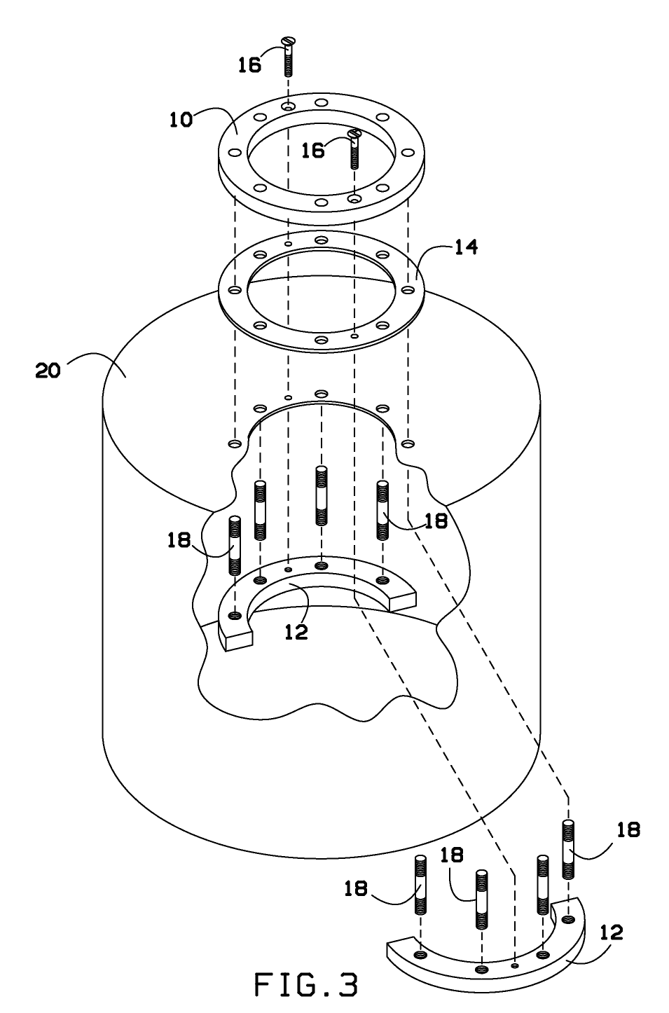

Referring now to FIGS. 1 through 3, the weld free flange system can be attached to a flat surface of sufficient size to a tank top 20. The weld free flange system has been primarily designed for atmospheric, above ground day tanks, such as UL142/2085 applications, however the weld free application has, of course, many application opportunities. The flange system is primarily designed for retrofit applications where welding at the installed location is not practicable.

Flange halves 12 pass through a pre-cut hole pattern in the component where a device is to be attached. An optional outside flange 10 can attach to the flange halves 12 using a gasket 14 by way of countersunk screws 16, following which attaching a device using studs or bolts 18 through the flange halves 12 and into the outside flange 10 can be achieved. Tightening the device clamps or sandwiches the component, providing a strong leak free attachment method.

Dimensions of the outside flange 10, gasket 14 flange halves 12, and related components can be modified to suit a given application and design criteria.

The following describes an exemplary procedure for creating a tank connection, according to an exemplary embodiment of the present invention.

First, all necessary safety precautions can be taken pertaining to one's personal safety and in full cognizance of national, local and jobsite safety rules and regulations. All necessary precautions can be taken to prevent ingress of metal shavings/drill/hole saw debris into tank. To limit ingress of metal shavings into tank, grease can be applied to drill bits and hole saws which will retain debris to grease. Drill bits and hole saws should be cleaned regularly and replenished with fresh grease.

A suitable location for the flange can be established on the tank. The selected location should a) be free of internal tank baffles or components and b) provide for sufficient headroom to gain required access for the device being attached and that the flange bolt pattern allows for a float switch terminal box to be in a desired location (2 hole top=traditional square with tank sides).

The flange can be used as a drill template to drill through the flange and through the tank. For example, ⅜ inch holes 180 degrees apart can be drilled. Holes for the bolts 18 can be drilled by, for example, a ⅜ inch drill bit. Locating holes, such as ¼ inch locating holes can be drilled. Of course, different size holes can be drilled depending on the application.

Using the flange as a template, a hole saw can be used to cut a hole in the tank, inside of the holes cut in for the retaining screws 16 and the bolts 18.

The flange template can be removed, any burrs can be removed and the top and underside of the tank can be cleaned. The tank can be inspected for any signs of debris and this debris can be removed.

Using Loctite® 243 or similar diesel resistant thread locker/sealer, eight two inch by 5/16-18 studs can be disposed in both halves of the flange halves 12. The stud ends should be flush with the rear of the flange halves 12. Of course, different sized studs can be used depending on the application.

Using the outer flange as template, holes can be drilled through the gasket 14 for the countersunk retaining screws 16.

Each half flange can be passed through the hole cut with the hole saw in the tank, with the studs 18 facing up and passing through the holes pre-drilled in the tank. The gasket 14 can be placed over the studs and the outer flange 10 can be placed over the gasket 14. The retaining screws 16, coated with a diesel resistant thread locker, can be passed through the outer flange 10, the gasket 14 and threaded into the flange halves 12. Tightening the retaining screws 16 can tighten and seal the tank connection to the tank.

While the Figures show flange halves, the flange halves 12 can be flange thirds, or flange quarters or various flange components that fit together to form the entire, donut shaped flange.

A float switch flange and float assembly or flange with similar hole pattern can be positioned over studs. The notch in the float switch flange should be positioned away from position of viewing as this ergonomic positioning is easier on attending technician when trouble shooting in comparison to Fuelogic drawings.

It should be understood, of course, that the foregoing relates to exemplary embodiments of the invention and that modifications may be made without departing from the spirit and scope of the invention as set forth in the following claims.

What is claimed is:

1. A tank or bulkhead connection device comprising:
at least first and second flange components adapted to fit inside an opening formed in a top of a tank, the first and second flange components forming a donut shaped second flange;
a plurality of bolts extending from the first and second flange halves and extending through bolt holes formed in the top of the tank; and
a gasket fitting about the bolts.

2. The tank or bulkhead connection device of claim 1, further comprising an outside flange formed in a donut shape and having outside flange holes for receiving the plurality of bolts therein.

3. The tank or bulkhead connection device of claim 1, wherein the first and second flange components are first and second flange halves.

4. The tank or bulkhead connection device of claim 2, further comprising counter sunk screws fitting through the outside flange and threading into the first and second flange components.

5. A tank or bulkhead connection device comprising:
at least first and second flange components adapted to fit inside an opening formed in a top of a tank, the first and second flange components forming a donut shaped second flange;
a plurality of bolts extending from the first and second flange halves and extending through bolt holes formed in the top of the tank;
a gasket fitting about the bolts;
an outside flange formed in a donut shape and having outside flange holes for receiving the plurality of bolts therein; and
counter sunk screws fitting through the outside flange and threading into the first and second flange components.

6. The tank or bulkhead connection device of claim 5, wherein the first and second flange components are first and second flange halves.
